(19) United States
(12) Patent Application Publication
(10) Pub. No.: US 2007/0047726 A1
(43) Pub. Date: Mar. 1, 2007

(54) System and method for providing contextual information to a called party

(75) Inventors: Fadi R. Jabbour, Sunnyvale, CA (US); Mukul Jain, San Jose, CA (US); Johnny H. Lee, San Gabriel, CA (US); David C. Lee, Sunnyvale, CA (US); Alan D. Gatzke, Bainbridge Island, WA (US)

Correspondence Address: BURGESS & BEREZNAK LLP, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/213,152

(22) Filed: Aug. 25, 2005

(51) Int. Cl. H04M 1/00; H04M 3/00

(52) U.S. Cl. 379/373.02; 379/373.01

(57) ABSTRACT

A telephone system includes a first endpoint device operable to populate a subject field with a message entered by a caller, and to send a call to a called party with the message being attached thereto. A second endpoint device is operable to retrieve the message when the call is received, and to communicate the message to a called party prior to the call being answered. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The present invention relates generally to the field of telecommunications; more specifically, to methods and apparatus for transmitting messages over a telephone network.

### BACKGROUND OF THE INVENTION

Digital telephone networks and telephone device technology continues to advance at a rapid pace. Notable achievements over the past decade include digital communications that carry both voice and data over channels of an Integrated Services Digital Network (ISDN), as described in U.S. Pat. Nos. 5,937,040 and 5,615,213; the combination of computer telephone integration (CTI) and a private branch exchange (PBX) system that enable custom telephone features for multi-function telephone sets (MTS), as disclosed in U.S. Pat. No. 6,798,874; telephone answering systems that provide security for a voicemail message platform, as taught in U.S. Pat. No. 6,912,275; and the development of Internet Protocol (IP) telephony networks and phone systems that provide call routing of packet-based voice over IP (VoIP) calls. By way of example, U.S. Pat. No. 6,918,034 teaches a method and apparatus to provide encryption and authentication of a mini-packet in a multiplexed real-time protocol (RTP) payload transported across an IP telephony network.

The sending of text messages and caller information over telephone lines is a technological area that has been the subject of much recent attention and development efforts. For instance, most cellular telephones sold today permit a user to send (by pressing the alpha-numeric keypad buttons on his or her phone) and receive text messages. Additionally, most modern telephones include the capability of displaying caller identification (caller ID) information such as the name of the person placing the call and the telephone number of the device from which the call originates. The caller's name may be mapped or associated with a particular telephone number and stored in a memory of the telephone device. An example of a system that utilizes caller identification information is found in U.S. Pat. No. 6,917,672, which teaches the notion of identifying parties to a call so that a third party authority—which may include a business, a parent, a court, or some other authority—can regulate calls according to caller and callee pairs. Similarly, U.S. Pat. No. 5,999,599 discloses a system and method in which a caller may record his identification prior to making a telephone call, with the recorded identification being sent along with each call the caller makes.

A number of Internet Service Providers (ISPs) also offer a feature known as Instant Messaging (IM), which allows a subscriber to type a text message on their personal computer (PC) and then immediately send that message to another connected person via the Internet. In certain implementations, after sending a text message a user may invoke a command (e.g., “click-to-dial”) that attempts to establish a voice connection over the Internet with the recipient of their text message. One drawback of this feature, however, is that the text message is lost or dropped whenever the call is transferred or re-directed to another number or person.

While telephone features such as text messaging and caller identification are valuable communication tools, there are certain situations in which more specific and timely information would be useful to a user. For example, when a person receives a call on a telephone today, their caller ID function is limited insomuch as it only provides the identity of the caller, and nothing about the context or reason for the call. Often times, a user would like to filter or screen their calls—only answering calls that relate to a certain subject matter, and allowing other low priority or less urgent calls to pass to their voice messaging system. In other words, there are times when it would be helpful for a called party to receive some information that conveys the reason or nature of the call, without requiring the called party to actually answer the ringing call.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is an example of a telephone device that may be utilized in accordance with one embodiment of the present invention.

FIG. 2 is a high-level conceptual diagram of a telecommunications system and network in accordance with one embodiment of the present invention.

FIG. 3 is a flowchart diagram that illustrates a method of operation according to one embodiment of the present invention.

FIG. 4 illustrates a user interface window associated with an application running on a PC of a user in accordance with one embodiment of the present invention.

FIG. 5 shows a user interface window on a display screen of a call recipient's PC according to one embodiment of the present invention.

### DETAILED DESCRIPTION

A system and method that associates a subject message with an incoming call and provides a called party with information regarding the nature or reason for the call prior to answering the call is described. In the following description specific details are set forth, such as device types, system configurations, protocols, applications methods, etc., in order to provide a thorough understanding of the present invention. However, persons having ordinary skill in the relevant arts will appreciate that these specific details may not be needed to practice the present invention.

According to one embodiment of the present invention, a message is associated with a call that is about to be placed. The message may take a variety of forms (e.g., text, voice, video, etc.) and may consist of any information that the caller wants to convey as a preface to the call. For example, the message may contain a brief explanation, reason, or context (i.e., subject) for the upcoming conversation/communication. In most cases, the subject is displayed on a screen or user interface of the called party's telephone device. Alternatively, or in addition to a visual display, the message may be audibly played out on a speaker of the called party's telephone device. In either case, the subject information accompanies the arrival of the call and is output substantially simultaneous with the call notification or ring event.

In one implementation, the user telephone device may be connected to an Internet Protocol (IP) software-based business PBX phone system that provides call routing of voice over IP (VoIP) calls. The IP-PBX system may comprise software or hardware (firmware) that includes executable code to implement the functionality and features described below. In another embodiment, the user telephone device may comprise a PC with VoIP capabilities. By way of example, in various embodiments the present invention may be implemented by one or more hardware/software modules installed in an IP communications system that includes components such as Cisco System's IP Communicator, Call Manager, Unity Unified Messaging, Softphone (a PC that has phone capabilities installed), and other IP phone products.

In a particular embodiment, the present invention may be implemented utilizing the Session Initiation Protocol (SIP), which is a known communication protocols described in Request For Comments (RFC) 3261 (June 2002). Session Initiation Protocol is the Internet Engineering Task Force's (IETF's) standard for multimedia calls over IP. SIP uses a request/response method to establish communications between various components in a network and to ultimately establish a call session or conference between two or more endpoints. Users in a SIP network are identified by a unique phone number and a unique SIP address, which is similar to an electronic mail (email) address. When a user initiates a call, a SIP request is typically transmitted to either a SIP proxy server or a redirect server. A SIP proxy server is an intermediate device that receives SIP requests from a client and then forwards those requests on the client's behalf. Proxy servers receive SIP messages and then forward them to the next SIP server in the network. Proxy servers can also provide functions such as authentication, authorization, network access control, routing, and security. A redirect server provides the client with information about the next hop or hops that a message should take, and then the client contacts the next hop server or user agent server directly.

In addition to address information, a SIP message may contain a start-line specifying the method and protocol, as well as a number of data packet header fields specifying call properties and service information. As described in Section 20.36 of RFC 3261, a SIP message includes an optional subject header field that is utilized in one embodiment of the present invention to convey the reason or context for the phone call or session. The subject header field is populated by the caller and is then retrieved and displayed or played out to the called party during the ring event. That is, in one embodiment the SIP subject header field is used to transport the context or reason for the call.

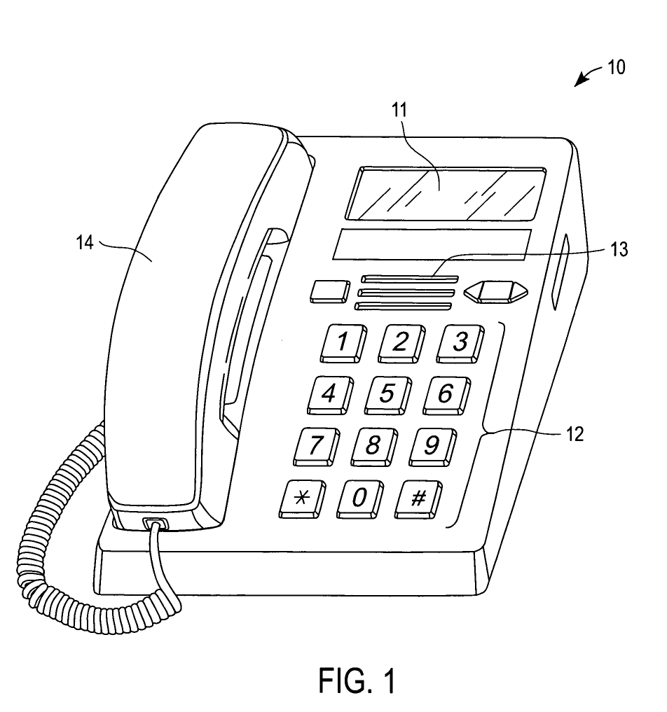

Referring to FIG. 1, there is shown an exemplary telephone device 10 that may be used as an endpoint for sending and receiving calls in accordance with one embodiment of the present invention. Telephone device 10 includes a handset 14, a standard alpha-numeric keypad 12, a speaker 13, and a visual display 11 that typically comprises a liquid crystal display (LCD) panel. Speaker 13 may be used to play out an audio message recorded by the caller. The audio message accompanies and is associated with the call, and may be played out during the ring event. For example, telephone device 10 may broadcast the audio message instead of ringing, or repeatedly play out the message between rings.

It is appreciated that other embodiments may utilize other alpha-numeric input devices for entering a text message for association with a call. For example, devices such as a character scanning device or an electronic tablet that converts pen strokes or handwriting into character that are then stored in digital format in the subject header field, may be also utilized.

A simple example of a brief voice (or text) message that conveys the reason for a call might be, “Urgent customer issue!” The caller ID may also be displayed along with the message. Presented with an urgent message relating to an important issue, a user would be likely to answer the call. Conversely, if the user was engaged in an important matter and received a new call prefaced with the message “Let's talk about last night's party”, he might chose to ignore the call or otherwise let the caller to leave a voice message.

In addition, or as an alternative to an audible output explaining the reason or subject of the call, display 11 may visually display a text message with the same call context information concurrent with the ringing of the telephone device 10. In either case, the called party receives advance notification of the reason or context of the call before actually answering telephone device 10. Based on the associated context information received and his current situation or preference, the called party can then decide whether or not to answer the call. In other words, providing a text or voice message about the nature of the call gives the called party valuable information resulting in more efficient use of his time.

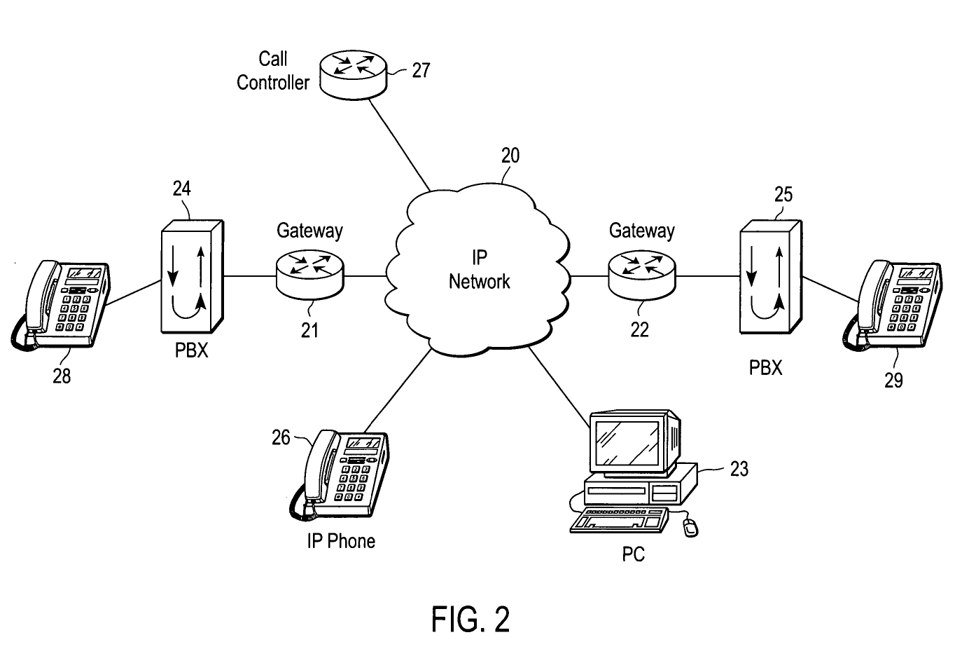

FIG. 2 is a conceptual diagram of a telecommunications system and network in accordance with one embodiment of the present invention, which includes a variety of endpoint devices interconnected via an IP network 20. Endpoint telephone devices 28 and 29 are each shown connected across IP network 20 via respective PBX systems 24 & 25 and gateway devices 21 & 22. In this embodiment, a call controller 27 may create, modify, or terminate calls between various other endpoints, such as SIP endpoints 28 and 29, for example. SIP gateway devices 21 & 22 provide call control and may also provide other services, such as a translation function between SIP call endpoints and other terminal types. This function includes translation between transmission formats and between communications procedures. In addition, gateway devices 21 & 22 may translate between audio and video codecs and perform setup and clearing on both the local area network (LAN) side and the switched-circuit network side (e.g., in a case where one endpoint connects via a PSTN).

The example of FIG. 2 also illustrates a SIP IP phone 26 and a personal computer (PC) 23 with IP phone capabilities connected to IP network 20. As will be described in more detail below, in one embodiment of the present invention, a user may populate a subject header field and initiate a call directly from an electronic mail client service or application. An example of such an application is Cisco's Unity Unified messaging program, which allows a user to listen to email messages over a telephone, check voice messages from the Internet, and send, receive or forward faxes to wherever the user may be located. Unity Unified messaging is operable to accepts calls from a proxy server and direct invites from a SIP-enabled end point (e.g., IP phone 26 in FIG. 2). Cisco's Unity application typically relies upon a proxy server or call agent to authenticate calls.

Practitioners in the arts will understand that context information associated with a call need not be transmitted across an IP network. In other words, the system and method of the present invention is also applicable to other types of public networks and intranet networks. For example, a PBX system of a business may be modified to associate a subject header text field with an internal call (employee-to-employee) to allow call filtering by the called party.

A voice, text, or multimedia (e.g., voice & video) message may be generated and then sent along with a call in number of different ways. In one embodiment, an interactive voice response (IVR) system, auto attendant, or speech recognition name dialer application may be employed to prompt the caller to enter (i.e., speak) the subject of the call after a beep. Known speech recognition technologies allow computers equipped with a source of sound input, such as a microphone, to interpret human speech for transcription purposes. For example, the SpeechAttendant™ application, offered by iVoice, Inc., of Matawan, N.J., is a commercially-available, speech-enabled, auto attendant that allows a caller to say the name of the person or department they want to reach instead of keypad entry of a number or extension. Speech-to-text input technologies that allow a user to dictate text messages simply by speaking—rather than inputting text by numerous taps of a keypad or keyboard—may be used to populate the subject message field associated with the outgoing call with a text string.

It is appreciated that the endpoint devices in the communications system or network are configured in accordance with the present invention with logic or software that enables populating the subject field with a message associated with the call (at the caller end) and retrieval of the message information (at the called party end) during the ring event prior to answering the call.

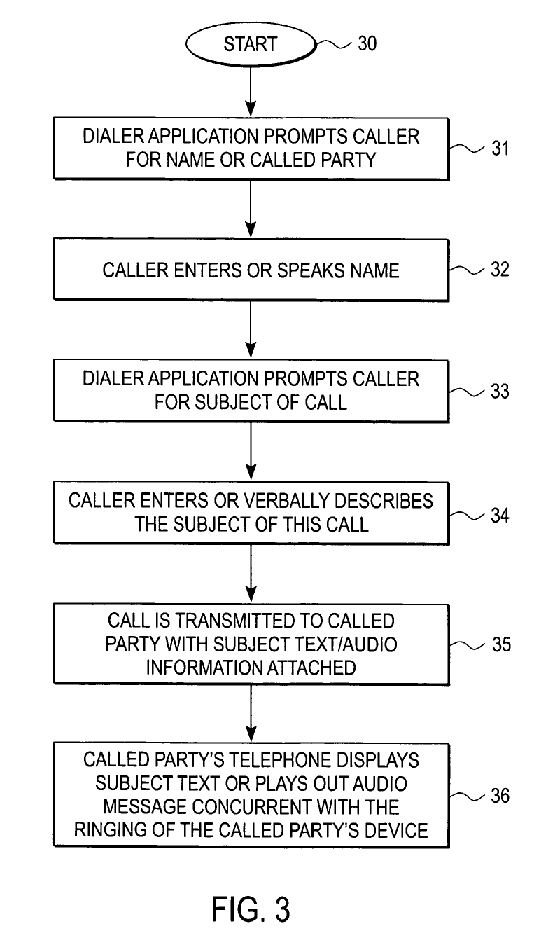

FIG. 3 is a flowchart diagram that illustrates a method of operation according to one embodiment of the present invention. The process starts (block 30) with a caller initiating a call at his endpoint device. This can occur when a user simply picks up the handset of a telephone, or when a person invokes a command on their PC to initiate an outgoing call. Once the call process is started, the caller is first prompted by a dialer application or auto attendant for the name (or number) of the called party (block 31). The user provides the name or number of the called party in this example either by speech-recognition or manual keypad/keyboard entry (block 32), and the application program then prompts the caller for the reason or subject of the call (block 33). Again, the message may either be spoken or manually entered by the caller (block 34), with the message eventually being stored in a subject field that is associated with the call. The subject message is thus attached to the outgoing call and transmitted to the called party (block 35). Note that if the call is re-directed or forwarded to another number or person, the subject message remains attached to the call according to this embodiment.

Regardless of the manner in which the message is recorded (text, speech, or video clip), placed and routed, some sort of call notification mechanism is employed at the called party endpoint device to notify the called party that an incoming call has arrived. A simple ring event may be used to signal the arrival of the incoming call. An auto attendant or dialer application may, for example, utilize third party call control (e.g., controller 27 in FIG. 2) to play out or replace part of the ring tone with an audio recording of the sent subject message. Note that even in cases where the caller had entered a text message by keypad entry, a text-to-speech application may be employed to translate that text message into an audible message played out on the called party's endpoint device. Alternatively, or additionally, the called party's telephone device may provide a visual display of the caller's text message (block 36).

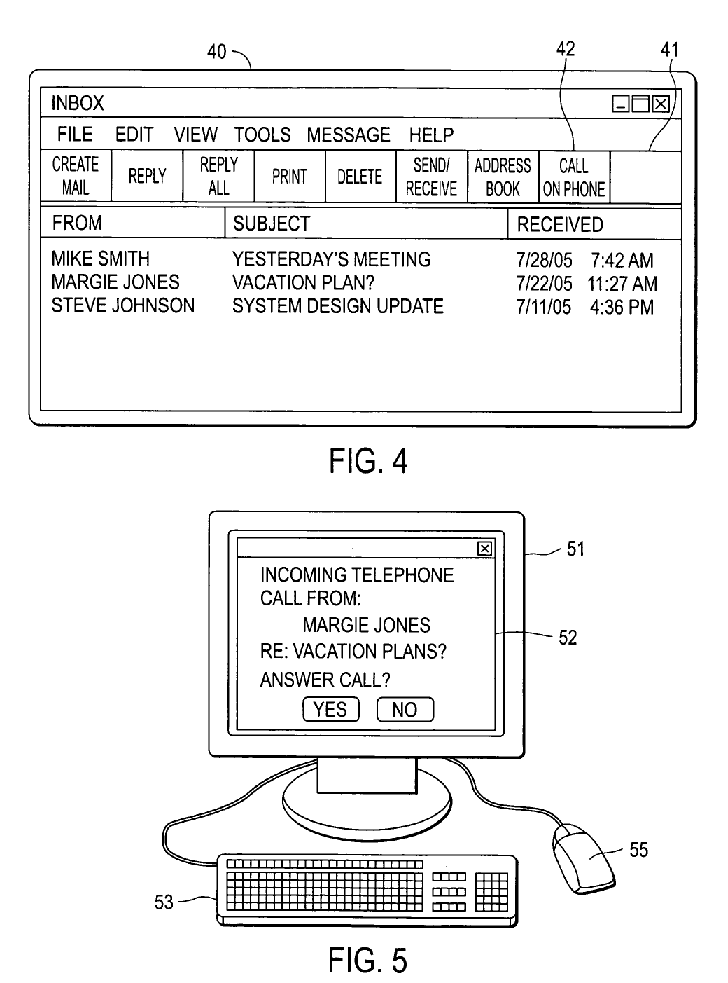

In still another embodiment, a caller may select an email stored on an email client running on the caller's associated PC. For example, FIG. 4 illustrates a user interface window 40 associated with an email client application running on a PC of a user in accordance with one embodiment of the present invention. At the bottom of user interface window 40 is an inbox listing of recently received email messages, with each message having an associated subject field. Such email messages are typically part of a thread of messages exchanged between the user and other parties.

Also included in window 40 is a toolbar 41 with a group of command icons or buttons that may be clicked on or otherwise invoked by the user. In accordance with the embodiment shown, clicking on or invoking toolbar button 42 immediately initiates a call to a highlighted or selected person from the message listing at the bottom of window 40. For example, highlighting the second message (from Margie Jones) in the listing group shown and then clicking on button 42 may initiate a call to Margie Jones. By selecting this email message and then initiating a call from the user's PC, the called party (in this case, Margie Jones) will be presented with the subject message at the same time she is notified of the incoming call.

Continuing with the present example, FIG. 5 shows a called party PC comprising a display monitor 51, keyboard 53, and mouse 55. Upon receiving the incoming call, an interface window 52 immediately pops up on display 51 notifying the called party of the caller's name and subject message information. In this example, window 52 also includes buttons presenting the called party with the option of answering the call or not. The called party is thus presented with the reason for the call and can therefore make an informed decision whether or not to answer the call.

In yet another embodiment, a user can select a call (on his PC or phone) for reply from a list of past calls that have either been received or sent by the caller. This operation is analogous to replying to a written email where the subject is reused to the outgoing message. In this embodiment, when the caller selects a past call and then initiates a new (or reply) call, the subject message associated with the selected call is automatically attached to the new call. In other words, this same subject message appears or is played out to the called party during the ring event—i.e., prior to the call being connected or answered.

It should be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer or telephonic device to a requesting process by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. For example, the present invention is equally applicable to cell phones, whether used for business or personal purposes. Accordingly, the specification and drawings are to be regarded in an illustrative rather than a restrictive sense.

We claim:

1. A telephone system comprising:
a first endpoint device operable to populate a subject field with a message entered by a caller, and to send a call to a called party with the message being attached thereto; and
a second endpoint device operable to retrieve the message when the call is received, and to communicate the message to a called party prior to the call being answered.

2. The telephone system of claim 1 wherein the message comprises a text message.

3. The telephone system of claim 1 wherein the second endpoint device communicates the message substantially simultaneous with a ring event.

4. The telephone system of claim 1 wherein the second endpoint device comprises a display, the message being communicated in a text format on the display.

5. The telephone system of claim 1 wherein the first and second endpoint devices each operate in accordance with Session Initiation Protocol (SIP).

6. A telephone device for sending/receiving a call comprising:
a microphone;
an alpha-numeric input device; and
a processor that executes code that prompts a user who wishes to place a call to enter a message, the message identifying a subject of the call, the message being attached to the call for subsequent transmission to a called party.

7. The telephone device of claim 6 wherein the message is entered via either the microphone or the alpha-numeric input device.

8. The telephone device of claim 6 wherein the alpha-numeric input device comprises a keypad or keyboard.

9. The telephone device of claim 6 wherein execution of the code causes the processor to operate in accordance with a protocol that includes a subject field for a call session, the subject field being populated by the message.

10. The telephone device of claim 6 wherein the call comprises a voice over Internet Protocol (VoIP) call.

11. The telephone device of claim 6 further comprising:
a display; and
a speaker, execution of the code causing the processor to output an attached message associated with an incoming call to the speaker and/or the display prior to the incoming call being answered.

12. The telephone device of claim 11 wherein the attached message is output substantially simultaneous with a ring event of the incoming call.

13. A processor-implemented method of initiating a call from a caller to a called party comprising:
prompting the caller to input a message that indicates a subject of the call;
receiving the message from the caller;
entering the message into a data packet field associated with the call; and
sending the call and the message to the called party.

14. The processor-implemented method of claim 13 wherein receiving the message comprises:
recording speech of the caller;
translating the speech into a text string.

15. The processor-implemented method of claim 14 wherein entering the message comprises populating the data packet field with the text string.

16. A processor-implemented method of receiving a call from a caller to a called party comprising:
retrieving a message associated with the call, the message indicating a subject of the call;
outputting the message substantially simultaneous with a ring event that notifies the called party of the call, the ring event occurring prior to the call being answered.

17. The processor-implemented method of claim 16 wherein outputting the message comprises displaying the message as a text string.

18. The processor-implemented method of claim 16 wherein outputting the message comprises audibly playing out the message as speech.

19. A method of operation for a communication device comprising:
running an application that displays a list of messages received by a user of the communication device;
selecting a message from the list, the message having an associated subject heading; and
invoking a command that automatically initiates a telephone call to a sender of the message, the associated subject heading being attached to the telephone call for display as a text string and/or audible speech output on a receiving communication device of the sender.

20. The method of claim 19 wherein entering the application comprises an electronic mail client.

21. The method of claim 19 wherein entering the communication device comprises personal computer.

22. The method of claim 19 wherein entering the communication device comprises a cellular telephone.

23. The method of claim 19 wherein entering the communication device comprises a voice over Internet protocol (VoIP) telephone.
